(19) United States
(12) Patent Application Publication
(10) Pub. No.: US 2003/0133009 A1
(43) Pub. Date: Jul. 17, 2003

(54) SYSTEM AND METHOD FOR DETECTING WITH HIGH RESOLUTION A LARGE, HIGH CONTENT FIELD

(76) Inventors: CARL S BROWN, SEATTLE, WA (US); PAUL C GOODWIN, SHORELINE, WA (US)

Correspondence Address: PILSBURY WINTHROP LLP, INTELLECTUAL PROPERTY GROUP, 11682 EL CAMINO REAL, SUITE 200`, SAN DIEGO, CA, 92130, US

(21) Appl. No.: 09/289,799

(22) Filed: Apr. 9, 1999

(51) Int. Cl. H04N 7/18

(52) U.S. Cl. 348/61; 382/128; 382/284; 348/142

(57) ABSTRACT

Successive portions of an array of small biological specimens are imaged using a CCD camera. The x,y coordinates of each successive portion within the array are also determined. The array is moved by a precision staging system to accurately locate each successive portion in the array. The separate data portions are then arranged together using the coordinates of each portion to produce a complete data image of the array, without any mathematical smoothing or matching necessary between successive portions.

### TECHNICAL FIELD

This invention relates generally to detection of high content field information such as arrays of small biological specimens, and more specifically concerns high resolution detection of such information using a high numerical aperture lens.

### BACKGROUND OF THE INVENTION

It is well known that biomedical research has made rapid progress based on sequential processing of biological samples. Sequential processing techniques have resulted in important discoveries in a variety of biologically related fields, including, among others, genetics, biochemistry, immunology and enzymology. Historically, sequential processing involved the study of one or two biologically relevant molecules at the same time. These original sequential processing methods, however, were quite slow and tedious. Study of the required number of samples (up to tens of thousands) was time consuming and costly.

A breakthrough in the sequential processing of biological specimens occurred with the development of techniques of parallel processing of the biological specimens, using fluorescent marking. A plurality of samples are arranged in arrays, referred to herein as microarrays, of rows and columns into a field, on a substrate slide or similar member. The specimens on the slide are then biochemically processed in parallel. The specimen molecules are fluorescently marked as a result of interaction between the specimen molecule and other biological material. Such techniques enable the processing of a large number of specimens very quickly.

A significant challenge exists in the scanning of such microarrays, due to their very high content, the relatively large size of the field, and the requirement of very high optical resolution of the scanning system due to the small size of the specimens. Generally, the scanning methods have been of two different types. The first uses a large charge coupled device (CCD) camera, while the other method uses laser scanning. The CCD camera approach typically includes a single, large format, cooled, charged coupled device camera, such as is available from Roper Scientific. In this approach, the entire array area on the slide (approximately 1 inch×1 inch) is illuminated, and the resulting fluorescence from the excitation of the fluorochromes in the specimens, referred to as a fluorescent image, is collected through a lens onto the single camera.

This approach has significant technical limitations, one of which is the inability to produce the required uniform illumination over the entire array area. While the lack of uniform illumination over the array can be compensated to some extent by software processing, usually the dynamic range and linearity of the resulting image is noticeably degraded. Also, the necessarily large macroscopic CCD lens must have a small numerical (NA) aperture, which ultimately limits the amount of light collected by the lens and, as a result, the sensitivity of the system.

The laser scanning approach is presently preferred, and suitable laser scanning systems are available from a number of commercial sources. The laser method does have disadvantages, however. As indicated above, laser light is specific in color and typically limited to one color, or in specialized cases, a few colors. Laser systems thus impose severe restrictions on the available light wavelengths for excitation of fluorochromes. Consequently, laser systems are optimized for a very limited number of fluorochromes. A system capable of looking at more than two fluorochromes simultaneously would be desirable.

Still further, the lasers used in such systems are typically unstable over short time periods, i.e. microseconds. Since short dwell times are necessary to efficiently scan microarrays, laser noise will occur, degrading the signal-to-noise ratio sufficiently to severely limit the detection capability of the system.

Further, laser light is coherent, i.e. the light is all in phase. The light can thus interfere with itself constructively and destructively, producing an effect referred to as “speckle”. This can add significantly to the noise in the data collected from the specimens, severely degrading the linearity and sensitivity of the device.

Still further, laser scanning systems use photomultiplier tubes for detecting the fluoresced light from the specimens; photomultiplier tubes, however, cannot provide high sensitivity and linearity at the same time, both of which are needed for accurate microarray scanning.

Hence, both of the above systems are limited in their detection capability of low intensity fluorescence. The present invention adopts a different approach which includes a number of improvements relative to the above systems, including a decrease in noise, higher sensitivity and linearity, as well as greater dynamic range with high accuracy. The present system provides a capability of high resolution detection of high content material at a rapid rate.

### SUMMARY OF THE INVENTION

Accordingly, the present invention is a system and method for scanning a plurality of specimens arranged within a scan area on a substrate, such as a slide, the system comprising: means for obtaining an image of a portion of the scan area, said portion having coordinates identifying its position within the scan area; means for moving the substrate and the image means relative to each other in a sufficiently precise manner so as to obtain images of successive portions of the scan area, as well as the coordinates thereof, to identify the position of the images relative to each other; and means for arranging the images, using the coordinates thereof, into a complete image.

### BRIEF DESCRIPTION OF THE DRAWINGS

FIG. 1 is a diagram of a prior art system using a CCD camera.

FIG. 2 is a diagram showing a prior art system using laser scanning.

FIG. 3 is a diagram showing the arrangement of the system of the present invention.

FIG. 4 is a diagram showing the arrangement of data using the system of the present invention.

FIG. 5 is a more complete arrangement of the data produced by the system of the present invention for a microarray.

FIG. 6 is a flow chart showing a portion of the software for the present invention.

FIG. 7 is a flow chart showing another portion of the software for the present invention.

### BEST MODE FOR CARRYING OUT THE INVENTION

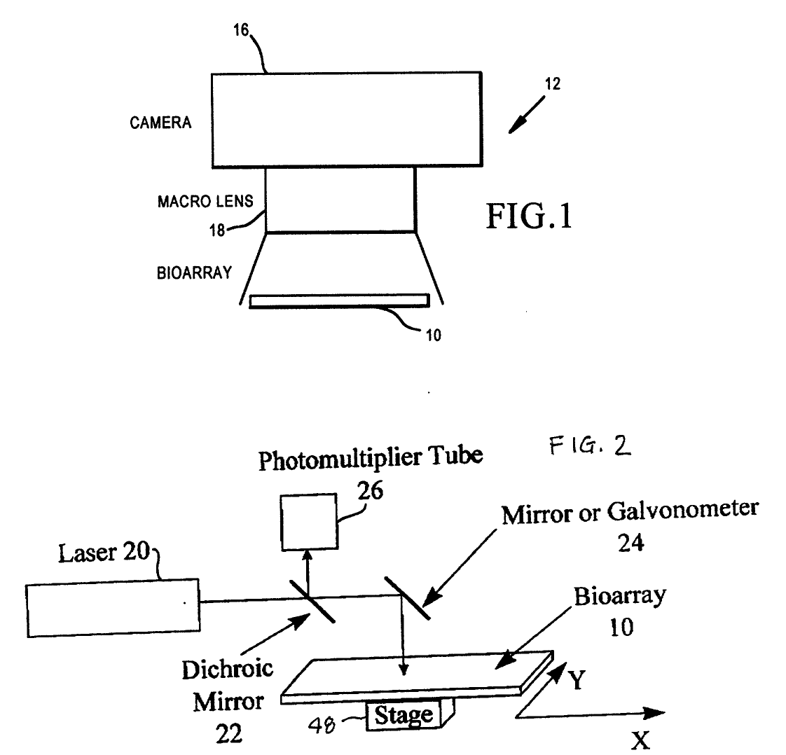

As discussed in the background portion herein, FIGS. 1 and 2 show current systems for scanning microarrays. The microarrays are positioned on a substrate shown generally at 10 both in the CCD camera system 12 of FIG. 1 and the laser scanning system 14 of FIG. 2. The substrate 10 can comprise a wide variety of materials and can have a variety of shapes and configurations. The substrate could be a polymer film or gel, but preferably is a flat, clear glass slide. In the embodiment shown, the flat glass slide is 3 inches by 1 inch by 1/25 inch (1.2 mm) thick.

A large plurality, typically 5,000-100,000, of individual biological specimens (for example a cDNA library, an oligonucleotide array or a protein array) may be contained in a typical microarray on a given slide. The large number of separate specimens results in an extremely high content field. Accurate detection of the data produced by the individual specimens requires a very high resolution scanning system. Again, as pointed out above, this high content field combined with the need for high resolution scanning presents a significant technical challenge.

Referring again to previous systems, FIG. 1 shows a simplified system involving a CCD camera 16 and a macro lens 18 focused onto a microarray of specimens on substrate 10. The microarray or field is illuminated by a separate light source (not shown) which is used to excite the individual specimens. An actual system would of course comprise several additional elements.

In FIG. 2, a laser light source 20 produces coherent light which is directed through a dichroic mirror 22, and reflected off a mirror/galvanometer 24 onto the microarray. The laser light excites the individual specimens to produce fluorescence, which is reflected off the mirror/galvanometer 24 and then off the rear surface of the dichroic mirror 22 to a photomultiplier detection tube 26, the output of which is the detected data. An example of such a system is shown in U.S. Pat. No. 5,578,832 to Trulson et al.

As pointed out in the Background of the Invention portion herein, both of these approaches have significant disadvantages, although the laser scanning approach is currently the clear system of choice. Research in this area is directed toward improvements in the laser scanning system.

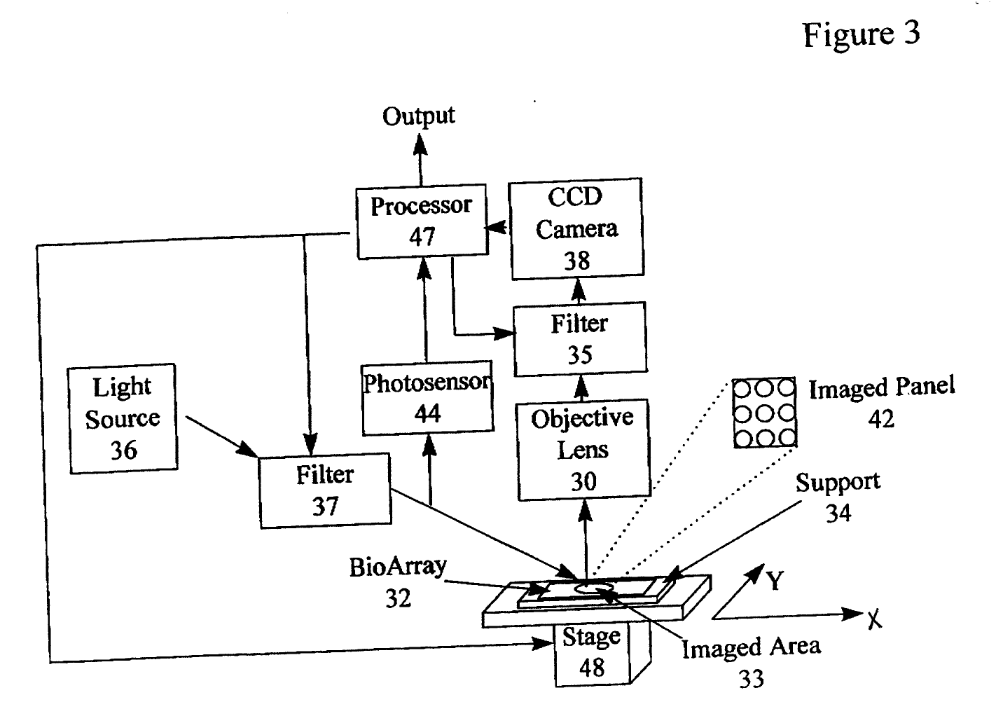

The present invention uses a substantially different approach, and in particular is directed significantly away from the currently preferred laser scanning approach. In the arrangement of the present invention, shown generally in FIG. 3, high content material, such as a microarray extending over a relatively large area (up to 2½ inches square) is accurately scanned with high resolution. An objective lens 30, with high resolution and high light collection efficiency characteristics, is used to detect the data in successive small portions (panels) of the microarray field 32 present on substrate 34. An example of such a lens is a Nikon 4× objective with a 0.2 NA.

Illumination for each panel, typically 1/10 inch (2.5 mm) square in size, which can, however, vary, is provided by a conventional white light (broad spectrum) source 36. The light (illumination) is directed obliquely to the array as shown in FIG. 3. This eliminates direct reflection of the illumination off the slide, although it is not necessary to the invention. The light from source 36 is applied to a filter 37 and then past a photosensor 44 before reaching the microarray 32. Photosensor 44 is used to measure the total amount of illumination delivered to the small target area (panel) of the microarray during each exposure of the camera. The photosensor measurement is used during a later processing step to correct small variations in light intensity from panel to panel, which typically amount to approximately 5%.

Excitation filter 37 is one of a plurality of filters held in a filter wheel by which a number of different excitation wavelengths can be chosen under software control. In the embodiment shown, the filter wheel may be easily changed; each wheel holds four separate filters. To minimize cross-talk between filter sets, the current embodiment uses dual filters in series to produce an additive extinction effect. The illumination is provided through a fiberoptic cable, which results in a highly consistent pattern of illumination.

Illumination of the array results in fluorescence from the biological specimens in area 33 on slide 35 which is then collected by objective lens 30. Panel 42 encompasses an area (shown as a square in FIG. 3) in which a total of nine biological specimens are located. The fluorescence data from these nine individual specimens is directed through lens 30, then through an emission filter 35, and then to the CCD camera 38, which detects an image of the array.

Emission filter 35, like filter 37, is one of a plurality of filters held in a filter wheel. As with the illumination filter, emission filter 35 may be selected through software control. In the embodiment shown, the emission filter wheel is easily changeable and may hold up to four emission filter sets, with each filter set comprising a pair of identical filters in series, for reduction of crosstalk and reflections.

It is possible that the system response (i.e. the sensitivity and offset) to area 33 may not be absolutely uniform. Each pixel in the image detected by the camera is compensated with gain and offset to produce a uniform response across the image. The response of each pixel is determined by an exposure series. Linear regression analysis of the exposure series data results in gain-offset values for each pixel. This is a common digital microscopy technique and results in all the pixels having the same light intensity, so that all areas of all panels have the same intensity. Images from the CCD camera and illumination information from the photosensor are applied to a processor 47, which will arrange all of the resulting pictures together, as discussed in more detail below.

The light travels from its source 36, through filter 37 and photosensor 44 to the specimens. Fluorescent emissions are collected by the objective lens 30 and passed through filter 35, on their way to the CCD camera 38. Such an optical system is generally conventional and therefore not discussed in detail. The general configuration of such systems, with the exception of oblique illumination, is present in fluorescence microscopes, such as available from Olympus and Nikon, or the assignee of the present invention.

The substrate with the microarray 32 is then moved successively by a precise moving system or stage 48. The initial position of the scanner system relative to the microarray is in one corner of the array referred to by x,y coordinates o,o. It should be understood, however, that the image system could alternatively be moved by a stage, with the array remaining stationary.

In this application, the position of each successive portion or panel of the array is thus known to an accuracy of approximately one picture element (pixel), repeatable to a fraction of a pixel. A very precise staging apparatus is shown in U.S. Pat. No. 5,812,310, owned by the assignee of the present invention and incorporated herein by reference. Such a staging apparatus can easily meet the requirements of the present invention.

Stage 48 is moved successively in the embodiment shown, such that eventually all of the information in the array is obtained, in the form of successive panels, each of which has an identifying set of stage coordinates. The panels are then put together to form a single, unitary image of the complete array by processor 47. With the high precision of the staging apparatus and the software control, which is explained hereinafter, the images can be joined together to form the image of the entire array with minimal or no mathematical processing to achieve alignment. It is not necessary to in any way smooth, i.e. align, the data between adjacent panels or to use computation techniques to string or connect the images together based on particular features of adjacent panels. The complete array thus can be constructed purely on the recorded position of the stage at each collection point, providing coordinate points for each panel are known.

With respect to staging accuracy, in some cases, the x,y axes of the stage are not exactly parallel with the pixel rows and columns in the camera. If the rotation angle between the stage and the camera is known, the camera can be rotated appropriately relative to the stage. The rotation angle can be determined, for instance, by adjusting the rotation angle until adjacent panels are aligned perfectly. The rotation angle, alternatively, can be used in the processing of the images, as explained below.

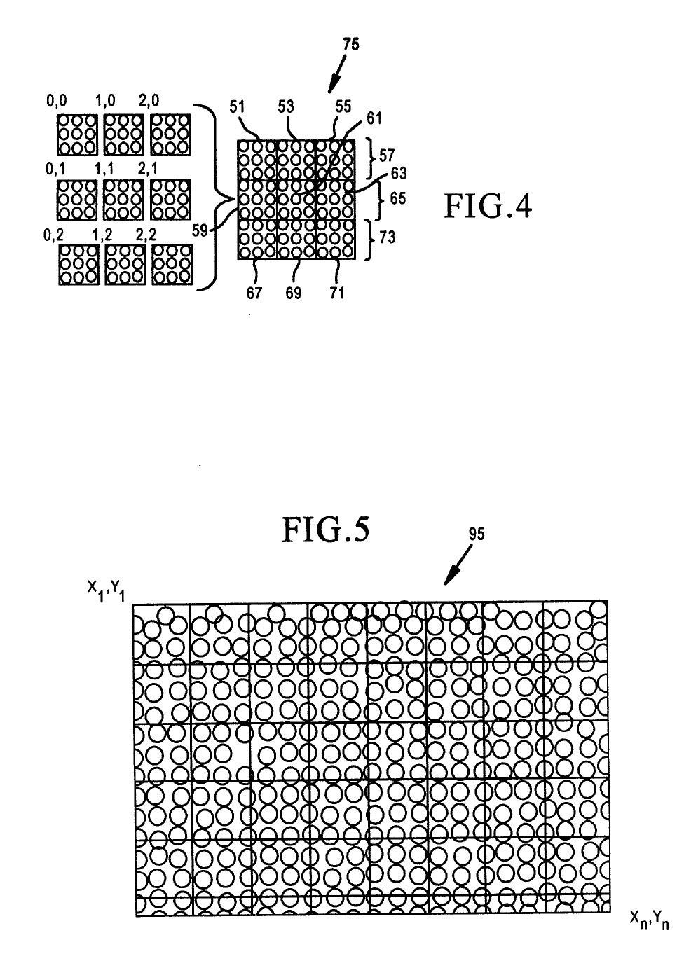

The “stitching” together of the panels is illustrated in FIG. 4, a nine panel array comprising 3 columns and 3 rows. Panels 51, 53 and 55 comprise an upper row 57; panels 59, 61 and 63 comprise a middle row 65; and panels 67, 69 and 71 comprise a lower row 73. Each panel has specific x,y coordinates indicating the position of the upper left corner thereof. The individual panels, imaged by the CCD camera, are arranged together by processor 47 to form a complete image 75 of the array field 32.

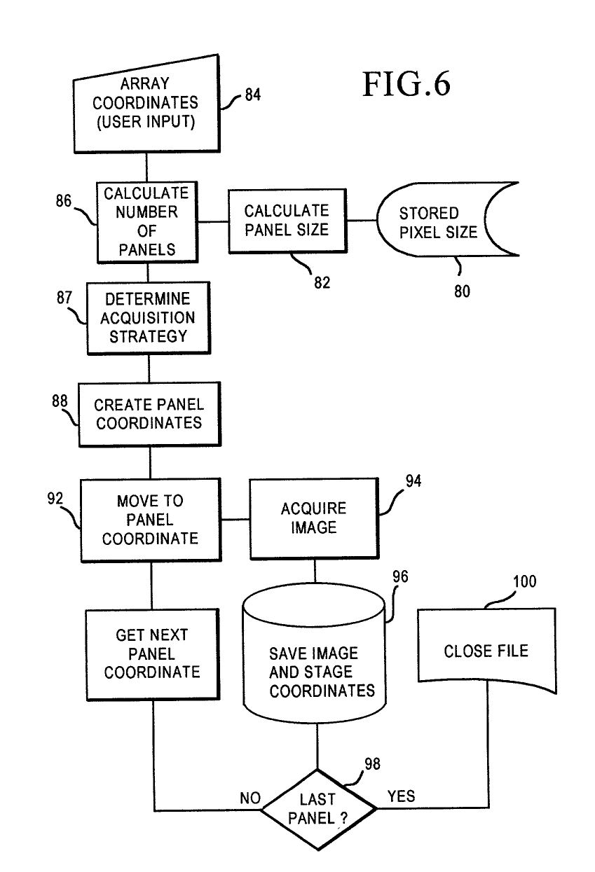

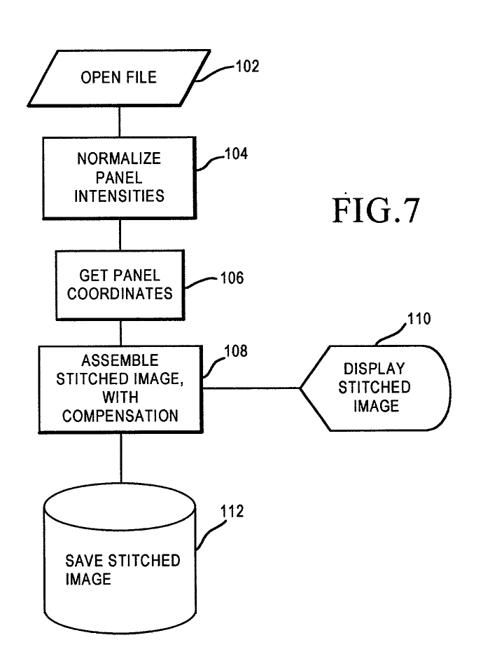

The process of obtaining the data in sequential steps and arranging the resulting panels together to form the complete image is shown in FIGS. 6 and 7. In FIG. 6, which shows the steps in acquiring the data, the pixel size of the information, which is known and previously stored (block 80), approximately 5 microns in the embodiment shown, is used to calculate the size of the panels (block 82). In the embodiment shown, this would be approximately 2½×2½ mm (1/10 inch), although it should be understood that other panel sizes could be used. The accurate determination of pixel size is important to accomplish the arrangement of the various images into a single picture. The exact area of a panel is determined by the number of rows and columns of the camera images and the size of the pixel. Where a single panel image comprises 500×500 pixels, the pixel size must be accurate to within 0.1% in order to limit placement errors of panels to less than ½ pixel. The pixel size can be stored for use by the processor. The size of the pixel can also be adjusted, if necessary, by conventional techniques.

As indicated in FIG. 6, the user provides the coordinates (block 84) for the array on the slide or other substrate. The coordinates in effect identify the actual physical boundaries and thus the size of the array.

From this resulting size of the array, and the calculated panel size, the total number of panels which will comprise the scanned array is then determined, as shown at block 86. Once the number of panels is calculated, then the particular manner in which the slide is maneuvered by the stage assembly to obtain (scan) the entire array is determined, as shown at block 87. For instance, successive images can be obtained in the direction of successive rows, either in one direction, or back and forth, or by successive columns, or some combination thereof.

For a particular scan area on a given slide, the location and size of each portion of the area covered by a single image must be determined, as well as the number of portions to cover the entire area. This is determined by the size of the scan area, the pixel size of the detector, the magnification in the image, and the dimensions of the detector array.

Following the determination of the image acquisition strategy, i.e. pattern, the x,y coordinates for each successive panel are then determined, as shown at block 88. The stage is then moved to the x,y coordinates of the first panel as shown at block 92, and the image at that position is acquired (block 94), as discussed above. The stage is arranged so that it only moves in x and y directions. It does not move in the z (height) dimension, so as to preserve correct focus over the array.

As indicated above, each panel image comprising nine individual biological specimens in the embodiment shown has very high resolution and is substantially uniformly (nonvariably) illuminated over the specific area of the panel. Variations in illumination detected by the photosensor are used by the processor to normalize the illumination from panel to panel. This first panel image (coordinates x₁ y₁ in FIG. 5) is then saved as well as the coordinates, as shown at block 96.

If the user has chosen to scan the specimens with more than one wavelength, the filter wheels 35a and 37a are changed to the appropriate excitation/emission filter pair and a new image is acquired and stored having the same coordinates as the first panel. This process may be repeated for any wavelengths that are selected. In the present embodiment, the total number of excitation/emission filter pairs may not exceed five. The stage 48 does not move when the filter pairs are changed so as to minimize chromatic aberrations in the final, complete image of the microarray. The net effect of this scanning technique is that each panel position may have data with multiple wavelengths, with substantially zero microns of lateral shift between filter (wavelength) pairs.

The software then determines whether the panel just obtained is the last panel in the array, shown at block 98. If not, the stage is moved to the next panel location, as established in the acquisition strategy table. The image is acquired for that panel and that information and its coordinates saved, shown at block 96. This repetitive process continues until all of the panels in the array have been imaged and saved, i.e. until panel xₙyₙ in array 95 of FIG. 5, for instance, has been obtained and saved. At this point, the file is closed, as shown at block 100, the acquisition process having been completed.

FIG. 7 shows the processing of the acquired data to produce the whole “stitched together” image of the complete array. In the first step, the file created by the software portion in FIG. 6 is opened, shown at block 102. The light intensities of the panels are normalized, as shown at block 104, to provide uniform values of intensity for each panel relative to each other. This is accomplished with information from the photosensor. Also, conventional techniques of correcting uniformity of illumination, pixel by pixel with gain/offset, known as “flat-fielding”, are carried out, as well as making the background intensity patterns of the panels the same, which is known as “panel flattening”.

Thus, the images are normalized over each separate image portion, such as a panel, and also normalized over the entire area being scanned, comprising all of the images. These techniques eliminate any resulting “patched” look for the final, complete image. The x,y coordinates of each panel are then obtained from the file, as shown at block 106. The panels are then assembled according to their specific coordinates, until the complete array image is produced, as shown at block 108. This is repeated for all filter/wavelength pairs collected for that sample. Compensation for rotation angle can be made during this process, and the known pixel size can be adjusted slightly if necessary to provide perfect alignment between adjacent panels. The assembled plurality of panels is then displayed, as shown at block 110. The complete image, with all of the wavelength information, is also saved, as shown at block 112.

Again, the individual separate panels, each comprising a small portion of the array, are simply put together on the basis of their coordinate values and are not mathematically smoothed or otherwise altered to fit together. This is because of the precise movement capability (with no movement in height) of the stage and the software which makes minor adjustments to illumination intensity and background over each image and over all the images and then assembles the individual panels of data into a complete image.

As indicated above, the present invention is significant in the scanning of biological arrays in that it is quite different from laser scanning methods, which are presently preferred. In the present invention, a full spectrum illumination source is used, along with a conventional scientific grade, cooled CCD camera, with its superior linearity and efficiency. A succession of individual panel images of the complete array of the various wavelengths are produced, with the panels then being pieced together with the aid of panel x,y coordinates into a complete image of the array.

In the present invention, a white light source, with available photons from approximately 350 nanometers to approximately 700 nanometers in length, can be used to scan more than two fluorochromes, using multiple probes, simultaneously. The number of fluorochromes is limited only by the specificity of the excitation and emission spectra of the fluorochromes themselves. Many specific applications become possible with this capability. In one example, an attempt to discover new pharmacologically active compounds, it is not enough to treat cells or organisms with a single dose of an agent at a single point in time and assume that the response is representative of that agent. In pharmacological research, the agents are introduced in a variety of doses and the response is monitored over time. The scanning system of the present invention can measure many probes simultaneously, which allows multiple doses or time points to be tested simultaneously under a single control.

In addition, with the ability to measure multiple probes, there is the possibility of using one pair of probes to measure overall gene expression, while others are used to monitor specific mutations, i.e. one pair of probes can be used to identify and “capture” specific gene products, while other probes can be used to screen specific mutations in those genes.

Further, there is the possibility of using the system of the present invention to study protein expression, in addition to the gene expression discussed immediately above. The field of protein expression, called proteomics, attempts to monitor specific proteins as indicators of cellular status. The present invention, with the capability of multiple wavelengths, makes it possible to do complex analysis on multiple proteins in parallel, as occurs presently for gene expression arrays.

Although a preferred embodiment of the invention has been disclosed, it should be understood that various changes, modifications and substitutions may be incorporated in such embodiment without departing from the sprit of the invention which is defined by the claims which follow.

What is claimed is:

1. A system for scanning a plurality of specimens arranged within a scan area on a substrate, comprising:
means for obtaining an image of a portion of the scan area, said portion having coordinates identifying its position within the scan area;
means for moving the substrate and the image means relative to each other in a sufficiently precise manner that images of successive portions of the scan area can be obtained, as well as the coordinates thereof, to identify the position of the images of the successive portions, respectively, relative to each other; and
means for arranging the images of the successive portions, using the coordinates of each portion, into a complete image which includes the plurality of specimens.

2. A system of claim 1, wherein the complete image is produced substantially without the aid of alignment techniques for the images of the successive portions.

3. A system of claim 1, wherein the successive portions of the scan area are substantially uniformly illuminated in turn.

4. A system of claim 3, wherein the system includes means for normalizing the image within each portion.

5. A system of claim 3, wherein the system includes means for normalizing the images of all portions within the scan area.

6. A system of claim 1, including means for storing the complete image.

7 A system of claim 6, wherein the portions each comprise a panel of data covering a plurality of individual biological material specimens.

8. A system of claim 7, wherein the specimens are mounted on a clear glass slide.

9. A system of claim 1, including means for supporting the substrate and wherein the moving means includes means associated with the support means for moving the substrate relative to the image means.

10. A system of claim 1, wherein the image obtaining means is a CCD camera.

11. A system of claim 9, including means for moving the substrate so as to provide a known sequence of portions until the entire scan area has been scanned, wherein each portion has known coordinates which identify its position within the scan area.

12. A system of claim 11, wherein the substrate is moved in two directions in a given plane with substantially no movement normal to said plane.

13. A system of claim 1, including means for initially storing each of the images and x, y coordinates thereof.

14. A system of claim 1, wherein the location and size of each portion and the number of portions comprising the scan area are determined on the basis of size of the scan area, pixel size of a detector portion of the image means, magnification and detector array dimensions.

15. A system of claim 1, including means for normalizing background intensity of the portions relative to each other.

16. A system of claim 1, including means for compensating for any rotation angle between the image means and the moving means.

17. A system of claim 1, including means for adjusting pixel size so as to accurately determine the portion area.

18. A system of claim 1, including means for illuminating successive portions of the scan area with a broad spectrum light source.

19. A system of claim 18, including means for obtaining a plurality of images of said portions of the scan area with different illumination and detection wavelengths, wherein a complete image is formed from the images of successive portions of the scan area for each wavelength.

20. A system of claim 19, wherein the plurality of images for the successive portions of the scan area have substantially no lateral shift between said different wavelengths.

21. A method for scanning a plurality of specimens arranged within a scan area on a substrate, comprising the steps of:
obtaining an image of a portion of the scan area, said portion having coordinates identifying its position within the scan area;
moving the substrate and the image means relative to each other in a sufficiently precise manner that images of successive portions of the scan area can be obtained, as well as the coordinates thereof, to identify the position of the images of the successive portions, respectively, relative to each other; and
arranging the images of the successive portions, using the coordinates of each portion, into a complete image which includes the plurality of specimens.

22. A method of claim 21, wherein the complete image is produced without the aid of alignment techniques for the images of the successive portions.

23. A method of claim 21, including the step of substantially uniformly illuminating successive portions of the scan area in turn.

24. A method of claim 21, including the step of normalizing the image within each portion.

25. A method of claim 21, including the step of normalizing the images of all portions within the scan area.

26. A method of claim 21, including the step of normalizing background intensity of the portions relative to each other.

27. A method of claim 21, including the step of compensating for any rotation angle between the image means and the moving means.
